(19) United States
(12) Patent Application Publication
(10) Pub. No.: US 2005/0128963 A1
(43) Pub. Date: Jun. 16, 2005

(54) Autonomous quality of service detection (AQD) in mobile equipment

(75) Inventors: Robert Gazda, Spring City, PA (US); Jeffrey T. Davis, Doylestown, PA (US); Narayan Parappil Menon, Syosset, NY (US); Douglas R. Castor, Norristown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/983,916

(22) Filed: Nov. 8, 2004

Related U.S. Application Data
(60) Provisional application No. 60/518,145, filed on Nov. 7, 2003.

(51) Int. Cl. H04B 7/005; H04L 12/56

(52) U.S. Cl. 370/278; 370/395.21

(57) ABSTRACT

A wireless transmit/receive unit (WTRU) comprises a terminal end and a mobile terminal. The terminal end provides packets for transfer over a wireless interface. The mobile terminal receives the provided packets and processes the packets for transfer over the wireless interface. The mobile terminal monitors the provided packets and determines whether a quality of service (QoS) change is desired. The mobile terminal requests a change of QoS of a wireless network based on the determination.

### CROSS REFERENCE TO RELATED APPLICATION(S)

This application claims the benefit of U.S. provisional application No. 60/518,145 filed Nov. 7, 2003, which is incorporated by reference as if fully set forth.

### FIELD OF INVENTION

The present invention relates to quality of service levels in wireless communication systems, and more particularly, to automatically detecting and modifying quality of service levels.

### BACKGROUND

In order to exchange data packets with cellular systems such as universal mobile telecommunications systems (UMTS) and global systems for mobile telecommunications (GSM), a wireless device establishes a data packet session with the cellular system or network. In establishing this data packet session, the wireless device applies for and is granted a virtual link to a network address, otherwise known as a packet data protocol (PDP) address. This virtual link, or PDP context, comprises not only a network address for sending and receiving data, but also quality of service (QoS) parameters in a QoS profile. Included in the QoS profile is information regarding the rate at which data is expected to be transferred during the life of the data packet session. The network considers these QoS parameters in light of available network resources to determine whether it can support the requested PDP context. A successful PDP context activation indicates that the network is able to provide an acceptable QoS level as indicated by the QoS profile.

FIG. 1 illustrates a conventional PDP context activation process 100. The process 100 is initiated by a wireless device 10. The wireless device 10 comprises terminal equipment (TE) 11 and mobile terminal (MT) 12. A TE can be described as a device which provides the capabilities for user applications including the user interface. MT is a general term used for any mobile station, mobile terminal, personal station or personal terminal, with which non-fixed access to a network is used. A few examples of TE/MT combinations are shown in Table 1. It should be understood that there exist many more TE/MT combinations then those illustrated in Table 1.

TABLE 1

| Terminal Equipment (TE) | Mobile Terminal (MT) |
|---|---|
| Microsoft Windows ® Personal | UMTS / GSM Modem Cards and |
| Computers | Mobile Telephones |
| Laptop and Desktop Computers | |
| All versions of Windows ®: XP, | |
| 2000, etc. | |
| Microsoft ® Pocket PCs | UMTS / GSM Modem Cards and |
| | Mobile Telephones |
| “One-box” Local Applications | Local UMTS / GSM Modem - |
| and Man Machine Interfaces | Protocol Stack |

TE 11 initiates the PDP context activation procedure by generating an Activate PDP Context Request Message (APCRM) during the TE/MT initialization and sending it to MT 12 (step 102). The MT 12 then sends the APCRM to the network 20 (step 104). Included in this Request Message is a QoS profile which contains both requested and minimum acceptable QoS parameters. After receiving the APCRM, the network 20 analyzes its resources and first attempts to provide the requested QoS parameters. If the network resources do not allow for the requested QoS, the network attempts to provide an acceptable QoS value somewhere between the requested QoS and the minimum acceptable QoS. If the network resources can accommodate an acceptable QoS, the network will activate a PDP context and send an Activate PDP Context Request Message Response (ARCRMR) to MT 12 (step 106), indicating the negotiated QoS profile. By way of example, a PDP context activation may include the steps set forth in block 108. Upon receiving the ARCRMR and accepting the negotiated QoS profile, the PDP context will be active allowing TE 11 to exchange packet data with network 20 at the QoS level assigned by the network 20 (step 112).

Once a PDP context is activated between a wireless device and a network, the QoS profile negotiated during activation (QoS1) will remain static for the life of the packet data session. If the QoS requirements change at some time after activation, under the current state of the art, the QoS1 may be insufficient to support the device's current application, potentially causing the session to terminate. Alternatively, the QoS1 may be higher then necessary thus wasting radio and network resources. To illustrate this further, consider a user running a Web browsing application wherein the TE is utilizing a single IP address and a single PDP context. If at some later time the user launches a video conference application requiring higher QoS, the video application will suffer because the TE is incapable of modifying the active QoS. Alternatively, if during activation the TE requested the highest possible QoS profile, the QoS will be higher then necessary when the video application is not running resulting in wasted radio and network resources. In either case, it is desirable to have a method to modify a QoS profile during an active session so as to maximize network performance without wasting network resources.

Two processes have been proposed for modifying a PDP context once the PDP context has been activated. The first of these proposed processes is illustrated in FIG. 2. FIG. 2 shows a PDP context modification process 200 wherein a Web browser application is active and a PDP context has an interactive QoS 202. At some later point in time, a video conference application is launched on TE 11 and TE 11 recognizes the video application as requiring a higher level QoS (step 204). As a result, TE 11 generates a Modify PDP Context Request Message (MPCRM) and sends it to MT 12 (step 206). The MPCRM contains, among other parameters, the QoS profile required to properly run the recently launched video application. MT 12 sends the MPCRM to network 20 (step 208). Similar to the context activation procedure, after receiving the MPCRM, the network 20 analyzes its resources and determines whether it can support a conversational QoS profile for the video application. Then, network 20 sends to MT 12 a response message indicating the newly negotiated QoS profile (step 210). Then, in step 212, the modified PDP context is accepted by the TE 11 and the initial interactive QoS is modified to reflect the newly assigned conversational QoS 212. Thereafter, the TE 11 begins to support the video application at an appropriate QoS level (step 214).

The second proposed approach does not propose modifying an already activated “primary” PDP context. Instead, this approach proposes to activate derivative or “secondary” contexts when new applications having different requirements are initiated. These secondary contexts are very similar to the initial or primary PDP context. In fact, secondary contexts inherit most of the attributes of the primary PDP context, including their association to the same PDP address as the primary context. The secondary contexts, however, comprise distinct QoS profiles enabling them to support distinct application demands.

Referring now to FIG. 3, a secondary PDP context activation process 300 is shown. As in FIG. 2, a Web browser application is active and a PDP context has an interactive QoS. In this process 300, however, the initial PDP context is a “primary” PDP context. At some later point in time, a video conference application is launched on TE 11 (step 302). Recognizing that the primary PDP context can not properly support the video application, TE 11 performs the same PDP context activation procedure described in FIG. 1. That is, TE 11 generates an Activate PDP Context Request Message (APCRM) and sends it to MT 12 (step 304). Included in this Request Message is a QoS profile necessary to support the video application. Then, in step 306, MT 12 sends the APCRM to the network 20.

After receiving APCRM and analyzing its resources, network 20 activates a new, secondary PDP context and sends an Activate PDP Context Request Message Response (ARCRMR) to MT 12 (step 308). Then, in step 310, the TE 11, receives the response message and accepts the negotiated QoS profile. At that point, the secondary PDP context becomes active, allowing TE 11 to properly run the video application (step 312). Meanwhile, the primary PDP context continues to service the initial application (step 314).

It should be understood that under this scenario, TE 11 may activate as many secondary PDP contexts as necessary to optimally support various applications. Each activated context, whether primary or secondary, can use the same IP address, eliminating the need to have multiple IP address on a per-application basis. Furthermore, once activated, the primary and secondary contexts remain active for the length of the session. For example, if a new application is launched after the video application terminates, TE 11 first determines if a PDP context, primary or secondary, with a QoS sufficient to support the new application is already active. If one such context exists, the new application will be mapped to the existing PDP context. Otherwise, the TE will activate another secondary context.

Implementing either of the two aforementioned approaches requires significant interaction between TE and MT. Since terminal equipment applications are not built with cellular quality of service modification in mind, TE/MT combinations are not capable of providing the interactions necessary to modify QoS. In fact, no TE has been produced that is capable of detecting the need to increase QoS. In addition, most TE/MT combinations do not support the concept of primary and secondary PDP context associated with a single PDP address. As a result, QoS adjustments do not occur. The QoS established when the session is initiated is utilized for the length of the session. This leads to two main problems. First, to avoid under-utilizing radio resources, a TE requests a nominal QoS profile. If at a time after activation the TE requires a higher QoS, it will be locked with the lower nominal QoS level, unable to properly support its application. Second, to avoid having insufficient QoS, the TE requests the highest possible QoS (e.g. maximum bandwidth, maximum reliability, etc.). At times when such a QoS profile is not necessary, radio and network resources are wasted and under-utilized.

Accordingly, it is desirable to automatically detect and modify the quality of service levels.

### SUMMARY

A wireless transmit/receive unit (WTRU) comprises a terminal end and a mobile terminal. The terminal end provides packets for transfer over a wireless interface. The mobile terminal receives the provided packets and processes the packets for transfer over the wireless interface. The mobile terminal monitors the provided packets and determines whether a quality of service (QoS) change is desired. The mobile terminal requests a change of QoS of a wireless network based on the determination.

### BRIEF DESCRIPTION OF THE DRAWINGS

A more detailed understanding of the invention may be had from the following description, given by way of example and to be understood in conjunction with the accompanying drawings wherein:

FIG. 1 illustrates a conventional user equipment (UE) originated packet data protocol (PDP) Context Activation process;

FIG. 2 illustrates a conventional UE originated PDP Context Modification process;

FIG. 3 illustrates a Secondary PDP Context Activation process;

FIG. 4A is a simplified block diagram of a wireless transmit/receive unit;

FIG. 4B is a simplified block diagram of a wireless transmit/receive unit; and

FIG. 5 illustrates the preferred embodiment of the present invention in an autonomous quality of service (QoS) Detection and Modification process.

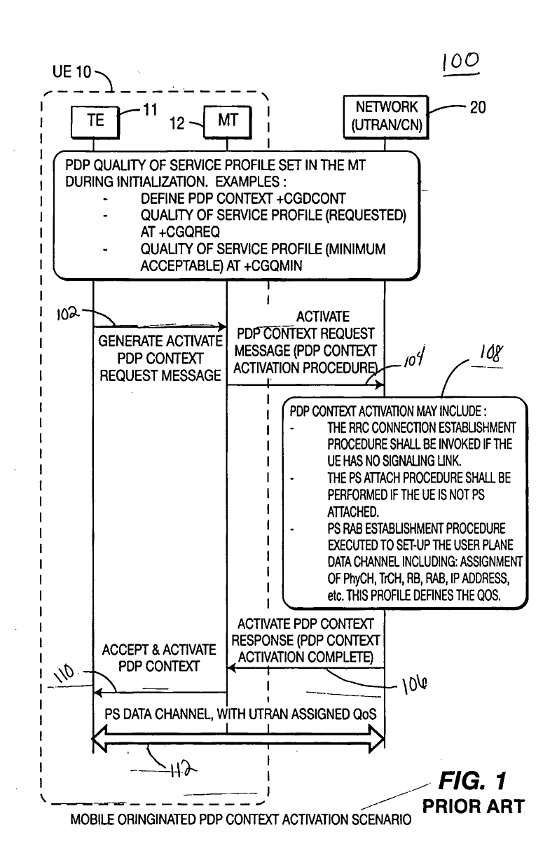

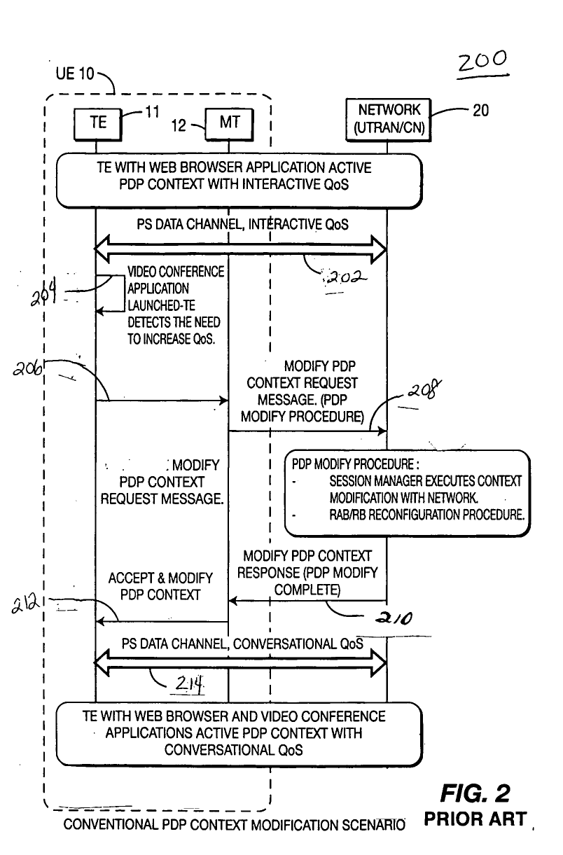

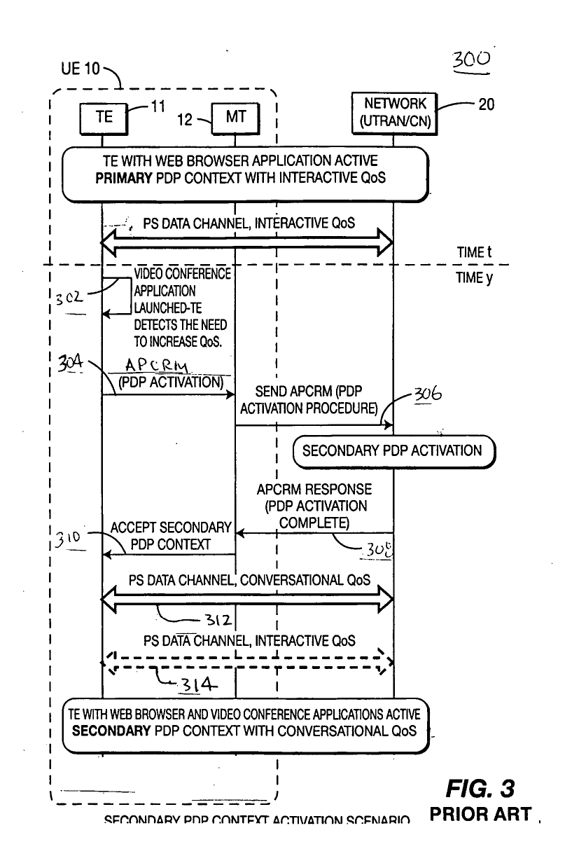

### DETAILED DESCRIPTION OF THE PREFERRED EMBODIMENT(S)

Although the features and elements of the present invention are described in the preferred embodiments in particular combinations, each feature or element can be used alone (without the other features and elements of the preferred embodiments) or in various combinations with or without other features and elements of the present invention.

Hereafter, a wireless transmit/receive unit (WTRU) includes but is not limited to a user equipment, mobile station, fixed or mobile subscriber unit, pager, or any other type of device capable of operating in a wireless environment. The WTRU may be used in a GPRS, UMTS, CDMA2000 or other wireless environment.

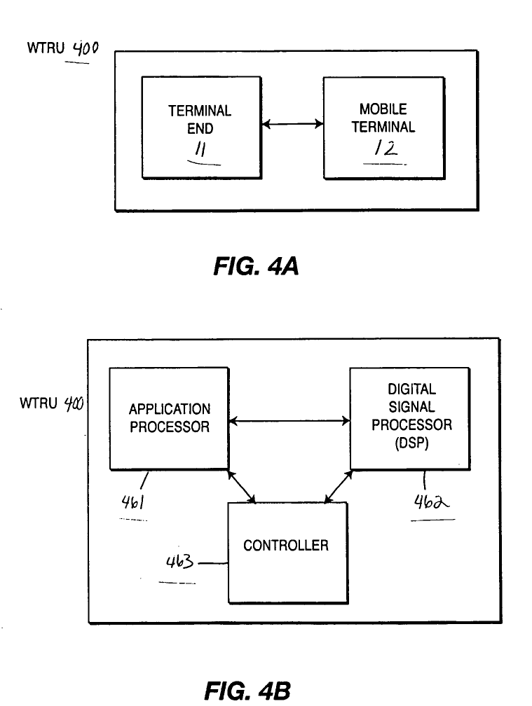

FIG. 4A is a simplified block diagram of a WTRU 400. As explained above, a WTRU 400 includes a terminal end 11 communicating with a mobile terminal 12. To further explain the WTRU 400 of the present invention, reference is now made to FIG. 4B. In FIG. 4B, there is shown a simplified block diagram of a preferred embodiment of WTRU 400. The WTRU 400 comprises an application processor 461, such as a RISC processor, for primarily performing application functions. A digital signal processor (DSP) 462, such as an ARM, primarily performs radio related functions. Although both processors are described as performing distinct functions, the functions performed by each processor may vary and may shift.

A controller is used to control the application processor 461 and DSP 462. The application processor 461 and DSP 462 communicate with each other, such as by using a bus or common memory. Although in a typical implementation, the application processor 461 would perform many of the terminal end operations and the DSP 462 would perform mobile terminal operations, the processor performing a specific operation would be based on the implementation and loading considerations. Although FIG. 4B illustrates WTRU components as separate components, these components may be on a single integrated circuit (IC), such as an application specific integrated circuit (ASIC), multiple ICs, discrete components or a combination of discrete components and IC(s).

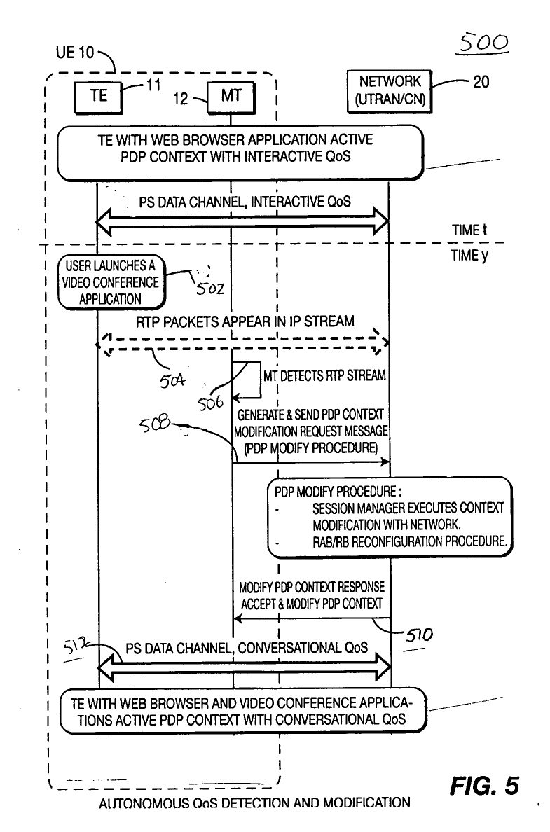

Shown in FIG. 5 is an embodiment of a QoS detection and modification process 500 in accordance with the present invention wherein a Web browser application is active and a PDP context has a nominal interactive QoS. MT 12 monitors both uplink and downlink transmissions searching for Real-Time Transport Protocol (RTP) traffic. RTP is an Internet protocol standard that specifies a way for managing the real-time transmission of data over a network.

At some later point in time, a video conference application is launched on TE 11 (step 502). As a result of the application launch, RTP traffic is generated (step 504). Utilizing RTP detection algorithms, MT 12 detects this new RTP packet (step 506). The detection of RTP packets occurs at any of several places in the MT 12 including: driver/inter-working modules between the TE and MT (e.g., serial driver/modem adapter), IP relay, RABM (UMTS), and SNDCP (GPRS).

Information carried in the RTP header includes the numbers of lost packets, round-trip time, and jitter. MT 12 processes this information and determines that a higher QoS level is required to support the video application. As a result, MT 12 initiates a PDP Context Modification Procedure by generating and sending a Modify PDP Context Request Message (MPCRM) to network 20 (step 508). The MPCRM contains, among other parameters, the QoS profile required to properly run the recently launched video application. After receiving the MPCRM, the network 20 analyzes its resources and determines it can support a conversational QoS profile for the video application. Then, in step 510, network 20 sends to MT 12 a response message indicating the newly negotiated QoS profile. Upon receiving and accepting the modified PDP context in message, the initial interactive QoS is modified to reflect the newly assigned conversational QoS and the TE 11 begins running the video application at an appropriate QoS level (i.e. conversational QoS) (step 512). Although this scenario requires conversational QoS, scenarios in which other QoS profiles, such as streaming class QoS (e.g., MP3, Media Player, etc.), may also be accommodated.

After the QoS level is modified, the MT 12 continues to monitor the network 20 traffic stream. Once the MT 12 detects the absence of RTP, the MT 12 will recognize that the video application has terminated and that the higher conversational level QoS is no longer required. In response, MT 12 will execute another PDP context modification procedure as described above, decreasing the QoS profile to a nominal setting.

MT 12 will continue to monitor for RTP traffic and modify the PDP context as necessary so long as the session is active. It should be noted that, in the present invention, interaction between TE 11 and MT 12 is not a requisite to modifying the QoS profile to a preferred level.

In an alternate embodiment of the present invention, MT 12 initiates a PDP Context Activation procedure to activate a secondary PDP context rather than modifying the primary PDP context. MT 12 generates and sends an Activate PDP Context Request Message (containing similar information as a MPCRM) to network 20, where the request is analyzed and a response is sent from the network 20 indicating a newly active PDP Context. Upon receiving and accepting the newly activated secondary PDP context, TE 11 begins to properly run the video application while the primary PDP context continues to service the initial application.

Although the features and elements of the present invention are described in the preferred embodiments in particular combinations, each feature or element can be used alone without the other features and elements of the preferred embodiments or in various combinations with or without other features and elements of the present invention.

1. A method for use in a wireless transmit/receive unit (WTRU), the method comprising:
(a) a terminal end providing packets for transfer over a wireless interface;
(b) a mobile terminal receiving the provided packets and processing the packets for transfer over the wireless interface;
(c) the mobile terminal monitoring the provided packets and determining whether a quality of service (QoS) change is desired; and
(d) the mobile terminal requesting a change of QoS of a wireless network based on the determination.

2. The method of claim 1 wherein the packets include Internet protocol (IP) packets.

3. The method of claim 1 wherein the terminal end primarily performs application related functions.

4. The method of claim 1 wherein the mobile terminal primarily performs wireless network interfacing related functions.

5. The method of claim 1 wherein the determination is based on the mobile terminal identifying Real-Time Transport Protocol (RTP) traffic.

6. The method of claim 1 wherein the mobile terminal performs step (d) using a PDP Context Modification procedure.

7. The method of claim 1 wherein the mobile terminal performs step (d) using a secondary PDP Context Activation procedure.

8. A wireless transmit/receive unit (WTRU) comprising:
a terminal end configured to provide packets for transfer over a wireless interface; and
a mobile terminal configured to:
receive the provided packets and process the packets for transfer over the wireless interface;
monitor the provided packets;
determine whether a quality of service (QoS) change is desired; and
request a change of QoS of a wireless network based on the determination.

9. The WTRU of claim 8 wherein the packets include Internet protocol (IP) packets.

10. The WTRU of claim 8 wherein the terminal end primarily performs application related functions.

11. The WTRU of claim 8 wherein the mobile terminal primarily performs wireless network interfacing related functions.

12. The WTRU of claim 8 wherein the determination is based on the mobile terminal identifying Real-Time Transport Protocol (RTP) traffic.

13. The WTRU of claim 8 further comprising a digital signal processor configured to perform operations of the mobile terminal.

14. The WTRU of claim 8 further comprising an application processor configured to perform operations of the terminal end.

15. A wireless transmit/receive unit (WTRU) comprising:
a terminal end comprising:
means for providing packets for transfer over a wireless interface; and
a mobile terminal comprising:
means for receiving the provided packets and processing the packets for transfer over the wireless interface;
means for monitoring the provided packets and determining whether a quality of service (QoS) change is desired; and
means for requesting a change of QoS of a wireless network based on the determination.

16. The WTRU of claim 15 wherein the packets include Internet protocol (IP) packets.

17. The WTRU of claim 15 wherein the terminal end primarily performs application related functions.

18. The WTRU of claim 15 wherein the mobile terminal primarily performs wireless network interfacing related functions.

19. The WTRU of claim 15 wherein the determination is based on the mobile terminal identifying Real-Time Transport Protocol (RTP) traffic.

20. The WTRU of claim 15 further comprising a digital signal processor for performing operations of the mobile terminal.

21. The WTRU of claim 15 further comprising an application processor for performing operations of the terminal end.

22. An integrated circuit comprising:
an application processor configured to primarily perform operations of a terminal end, the terminal end configured to provide packets for transfer over a wireless interface; and
a digital signal processor configured to primarily perform operations of a mobile terminal, the mobile terminal configured to:
receive the provided packets and process the packets for transfer over the wireless interface;
monitor the provided packets and determine whether a quality of service (QoS) change is desired; and
request a change of QoS of a wireless network based on the determination.

23. The integrated circuit of claim 22 further comprising a controller for controlling the application and digital signal processors.
